(19) United States
(12) Patent Application Publication
(10) Pub. No.: US 2010/0030713 A1
(43) Pub. Date: Feb. 4, 2010

(54) CONTENT ENGINE

(75) Inventors: Alastair Simpson, London (GB); Peter Bryant, Hampshire (GB); Ed Darnell, Middlesex (GB); Mark Eardley, Hertforshire (GB)

Correspondence Address: MCDERMOTT WILL & EMERY LLP, 18191 VON KARMAN AVE., SUITE 500, IRVINE, CA, 92612-7108, US

(73) Assignee: ICOM Limited, Sutton, Surrey (GB)

(21) Appl. No.: 12/302,280

(22) PCT Filed: May 24, 2007
(86) PCT No.: PCT/GB2007/001920

§ 371 Date: Aug. 17, 2009

(30) Foreign Application Priority Data
May 24, 2006 (GB) 0610340.2
Jan. 15, 2007 (GB) 0700748.7

(51) Int. Cl. G06F 17/30; G06Q 30/00; G06F 3/048

(52) U.S. Cl. 706/11; 707/5; 707/E17.108; 705/14.52; 705/14.66; 715/738

(57) ABSTRACT

There is described a computer system for determining the relevance of stored content to particular users and for facilitating the provision of relevant content to individual users. The computer system comprises a content engine comprising user profile information, representative of interests and/or attributes of individual users, and a processor for determining a correlation between content and said user profile information to determine content most relevant to a particular user.

### FIELD OF THE INVENTION

The present invention relates to a content engine for establishing relevant content, and in particular but not exclusively, to a web portal application that uses the content engine for accessing internet and local network content relevant to users.

### BACKGROUND OF THE INVENTION

In the modern world of digital communications and computing there is a great deal of electronic information available. Indeed, the magnitude of this information is often so overwhelming that it is becoming more and more important to be able to perform some sort of data mining or filtering operation in an attempt to recover more relevant information. The internet is a particularly vast source of information, which draws from a plurality of existing data storage areas and wherein more are added daily. As a result, some of the most successful websites are search engines that attempt to provide a user with a more narrowed set of results.

Such search engines can take on a plurality of different forms. For example, there are general search engines or more specific search engines which focus on particular subject areas, for example scientific research, literature, etc. Most of the search engines are based on a user inputting a particular text string describing the content which is sought and an engine that processes the content to find documents which relate to the search string.

However, a disadvantage of these search engines is that the accuracy of the results retrieved is limited by the particular key words that a user chooses to input as a search string. No other factors are taken into account.

Furthermore unscrupulous website providers are deliberately exploiting keywords to increase traffic to their websites.

Moreover, while there exist general web portals that users might register with in order to share or partake in a common service, such web portal applications do not provide content in a manner which discriminates between users of the service.

### SUMMARY OF THE INVENTION

According to aspects of the present invention there are provided many independent innovations as set out in both the following description and the appended claims.

### BRIEF DESCRIPTION OF THE DRAWINGS

Embodiments of the present invention will now be described by way of example only with reference to the accompanying drawings:

FIG. 1 shows the architecture of an exemplary communication system according to an embodiment of the present invention;

FIG. 2 shows a server of an ASP (Application Service Provider) for supporting a website according to an embodiment of the present invention;

FIG. 3 shows exemplary data structures of an embodiment of the content engine;

FIG. 4 shows an example of scoring for a behaviour;

FIG. 5 shows exemplary predicted data structures of an embodiment of the content engine;

FIG. 6 shows a comparison of exemplary predicted and declared data structures;

FIG. 7 shows a Venn diagram representative of the relatedness between sets of users;

FIG. 8 shows an index listing for determining interactions between sets of users;

FIG. 9 shows a specific example of an index listing applied by a statistical engine;

FIG. 10 shows a screen illustrating a plurality of questions posed to a user of the website;

FIG. 11 shows a screenshot of a homepage with links to a plurality of channels;

FIG. 12 shows an embodiment of a content engine; and

FIG. 13 is an overview of a process leading to creation of a relevance resource for use in provision of relevant content to users.

### DESCRIPTION

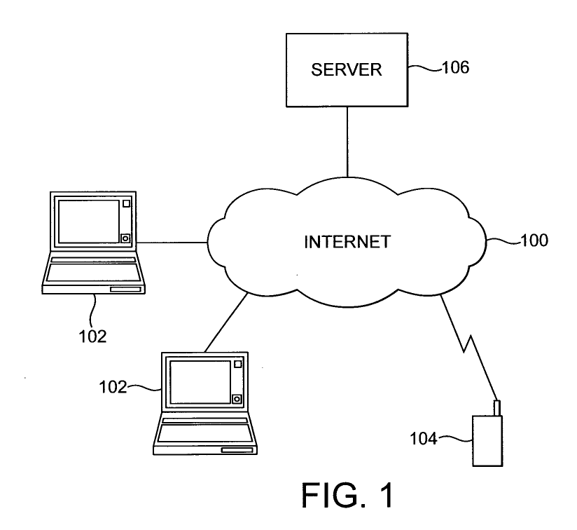

FIG. 1 shows an exemplary communication system according to an embodiment of the present invention which for example comprises the internet for interconnecting a plurality of devices. Examples of these devices are the computer terminals 102 and the mobile phone 104. The computer terminals 102 may connect to the internet 100 using DSL, broadband or a dial ISP, for example. The mobile phone 104 may connect to the internet over cellular networks, for example. It should also be appreciated that other terminal devices, for example laptops, PDAs (Personal Digital Assistants), loaded with the appropriate web browsing functionality are able to browse a website hosted by the server 106.

More particularly, the server is owned and maintained by an ASP (Application Service Provider) which provides a website or web portal application for registered users. According to a preferred embodiment, the web portal application is concerned with providing life choices in advance for young people and is tailored to provide relevant information content depending on the personal interests and attributes of each user that is registered with the ASP 106.

Specifically, FIG. 1 shows a user 102 able to interface with a communication network, such as the internet 100. That is, a user 102 is able to search for relevant content or information stored in a database, either locally or connected via the internet 100. In addition, or in the alternative, various applications are able to “push” relevant content to a user 102.

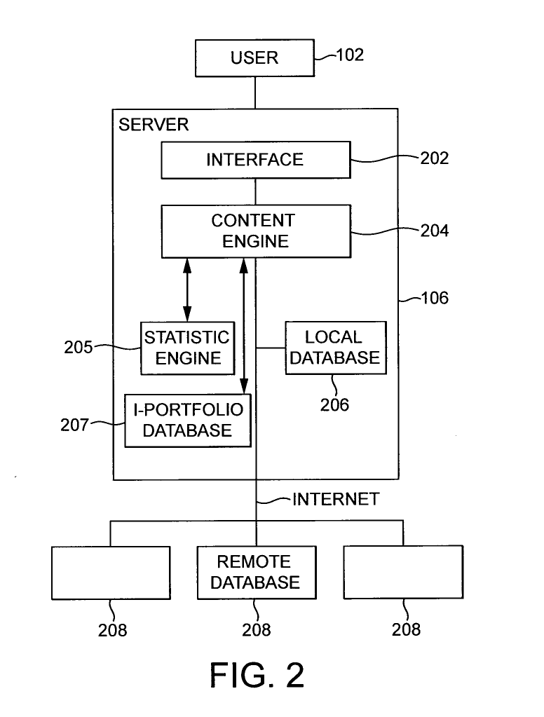

FIG. 2 shows an example of the functionality of the computer system, such as server 106. The various elements of functionality represented in FIG. 2 can be implemented by way of computer programs or software responsible for performing the various functions of the web portal. For example, the interface 202 is likely to be HTML-based software for supporting a website that can be browsed by respective user terminals 102, 104.

In one embodiment, a user 102 performs a search through the ASP 106. The ASP 106 is connected to the internet 100 wherein the ASP 106 provides an interface to the user 102 for accessing internet or local network content. While at least some of the content accessed is stored locally 206 in the server, much of it can be drawn from data stores 208 on the internet 100. Alternatively all of the content searched may be stored on the server, or further alternatively, all of the content searched may be drawn from the internet. It should be appreciated that content stored in a data store is taken to mean data, but is not intending to be limiting in that the content of a data store might comprise any of a plurality of different types of content in the form of various types of files, documents and/or portions thereof which might be sorted based on their relevance to the user.

The content engine 204 is used to build up knowledge of a particular user, through prompting the user to input information about their interests or behaviour, and based thereon to sort the relevance of content stored in either a local content source 206, or a remote content source 208, or a combination of remote and local content sources, in order to provide a user with knowledge which most closely matches the user's interests.

The content engine 204 is also able to build up a profile, representing the interests and personal attributes of a user, depending on their input to the website. One way of doing this is by generating a set of questions to be answered by the user. Further batches of questions are also asked to the user over time and can be based on existing knowledge of the user, for example based on answers to previous questions, or monitoring user browsing behaviour. This is explained in more detail below.

FIG. 2 shows the ASP 106 as having an interface 202 providing access to the content engine 204, which is able to determine and deliver relevant content to the user 102.

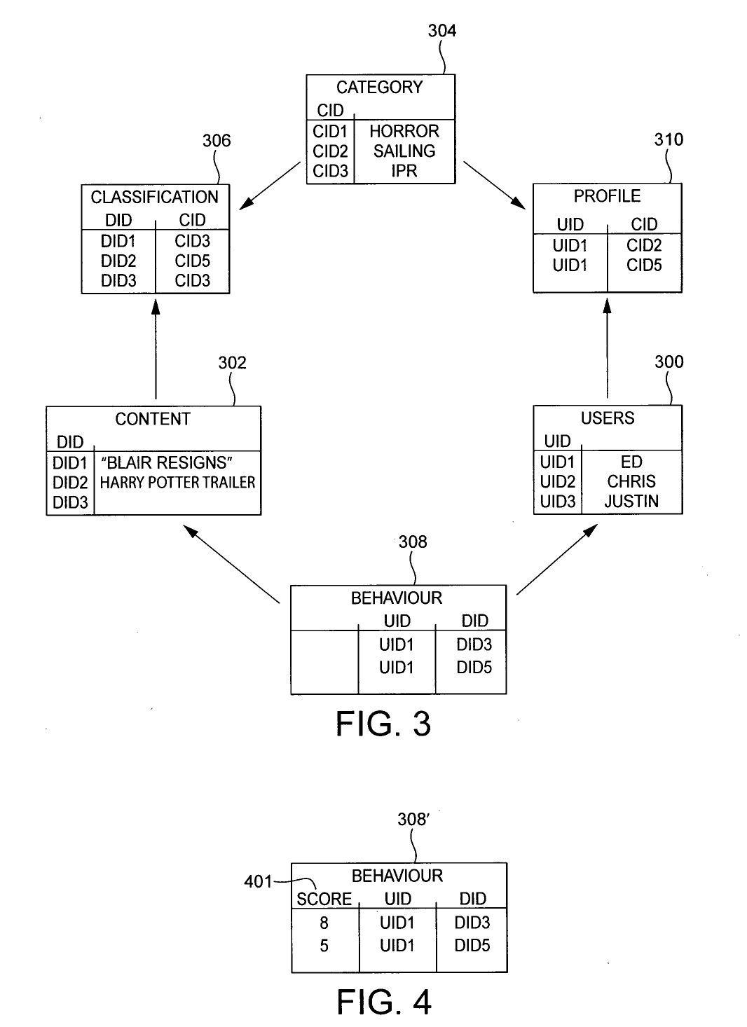

FIG. 3 shows exemplary elements of a content engine 204, including three primary data structures (“tables”): Users 300, Content 302 and Categories 304. These primary tables each have a relationship table between them: Classification 306, Behaviour 308 and Profile 310. Specifically, the classification relational table 306 defines the relation between the category 304 and content 302 primary tables. The profile relational table 310 defines the relation between the users 300 and category 304 primary tables. The behaviour relational table 308 defines the relation between users 300 and content 302. As will be appreciated, each such table will in practice contain very many more entries than shown. Although the configuration disclosed herein is not to be regarded as limiting, the content engine is coupled to a statistical engine 205 and a component labelled I-portfolio 207, which contains user profile information representative of user's interests and/or attributes. In some embodiments, the components 205 and 207 are provided within the content engine 204. As will be explained in more detail hereinafter, the user profile information of preferred embodiments includes information declared by users, information derived from tracking usage and further information deduced (predicted) based on statistical analysis of declared and/or derived information of all users.

The primary tables are explained in more detail below.

The table of users associates a unique number (UID) with each of the users known to the system 106. So for the example shown in FIG. 3 the lists of known users are Ed, Chris and Justin, which are associated with UID1, UID2 and UID3 respectively. In a further embodiment, the user table 300 is also able to hold (or have a link to): login details, contact and/or other personal information for the user. It is not so important as to the form of data stored about a user, rather the purpose is to allow a unique identifier (for example a numerical code) to be assigned to uniquely identify each of the users that accesses the service provided by the system 106.

The content table 302 associates a unique document identifier (DID), for example a number, to each piece of content that the system is aware of (i.e. either from a local source of content 206 or a remote source of content 208). The content table 302 generally holds a link (e.g. a filename or web URL) rather than the content itself. There is no restriction on the definition or format of the content. For example, the content may take the form of a news article, a movie trailer, a photo, a music track, etc and/or groups or parts of such items. However, anything which may be discretely identified may be recorded as a piece of content, since all that is needed is for the system to assign a DID for the corresponding content to be discretely identifiable.

The category table 304 associates a unique category identifier (CID), for example a number, to each category that has been generated by the system. Categories are grouping/classification mechanisms for example for users and/or content. Categories for example might include: the genre of film content (horror, romance, thriller etc), declared user groups (e.g. sailing special interest forum) or even socio-demographic groupings (age, wealth, personality type etc.).

It should be appreciated that in order for unique identifiers (i.e. UID, CID and DID) to be assigned to new users, categories and content respectively; the content engine is equipped with known functionality (not shown in FIG. 2) that is able to tag and identify these respective items.

The three relationship tables: classification 306, profile 310 and behaviour 308 are many-to-many linking tables. In one embodiment they are implemented using relational databases, wherein each relational database is able to record unique identifiers (IDs) showing a relationship between the two items which these IDs refer to. For example, an SQL mechanism for holding many to many relationships, allowing the content engine to record that one user is interested in many items of content, and conversely that one item of content is of interest to many users.

The profile table 310 records the relationship between users and categories (i.e. which categories of information each user is interested in). The profile table 310 thus has UID and CID entries to indicate these relationships.

The classification table 306 records the relationship between content items and categories (i.e. which of the classifications the content is associated with). The table thus has DID and CID columns to hold these relationships. In one embodiment, this table is typically populated from meta-data already included with the content itself. For example, locally held content already has meta-tags that give classification information. Content sourced from the internet may also have meta-tag information.

The behaviour table 308 records the relationship between users and content (i.e. which of the content items a user has looked at). The table thus has UID and CID columns to hold these relationships.

Each of the above tables is relatively sparsely populated such that tables only record data that is known to be substantially factually correct. Information declared by the user and regarding that user is regarded as substantially factually correct. Such declared information can for example be built up by the system generating questions which it prompts the user to answer, as will be described in more detail later. However, a given user may have no declared profile entries or may have very limited entries in the behaviour table (if they are a new or infrequent user of the content). That is, the behaviour data is the table which records the relation between users to the content that they access. This information is derived from browsing behaviour over time. Obviously over time, as the user accesses content via the system, more entries will exist for that user in the behaviour table.

In a preferred embodiment each of the relational tables 306, 308 and 310 are extended to include a “scoring” column. See the exemplary table 308′ of FIG. 4. This is used to store a numeric value representing the relatedness (‘strength’ of the relationship) between two items. The relatedness score may then be used to determine the overall relevance as will be explained in more detail below. All relationships within the system have date (timestamp) and relatedness score values associated with them.

In the case of declared and derived data the relatedness score value is either directly given by the user (their own rating of how important something is) or a value automatically assigned by the system based on a prediction of how strong the users actions suggest the relationship is (e.g. buying a piece of content would give a higher score than simply browsing to it from a free hyper-link). A relatedness score could for example be a mark out of 10 or a percentage, where in the example of FIG. 4 the content identified as DID3 is more relevant to a particular user (UID1), than another piece of content DID 5. This is represented in that the former relationship has a higher score “8” as compared to the latter “5”.

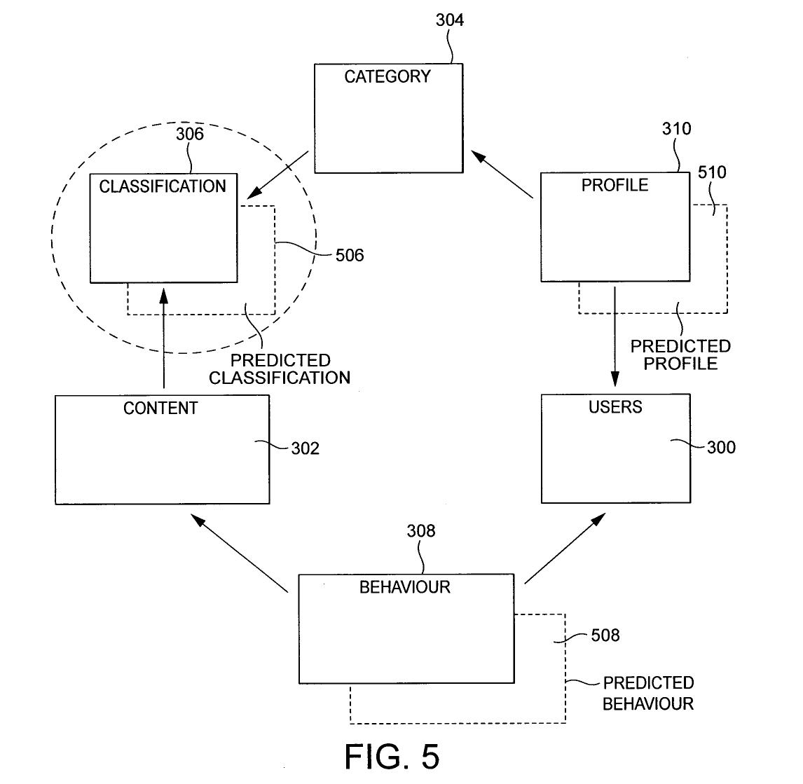

In a preferred embodiment the relational tables 306, 308 and 310 and predicted relatedness scores within them comprise predicted relationship information obtained through relatedness calculations by the statistical engine 205. See for example the predicted information of tables 506, 508 and 510 of FIG. 5. This predicted information generally mirrors the type of information in the declared or derived tables 306, 308 and 510, respectively. However, it is generated in instances (not necessarily all instances) where actual declared or derived relationships are not available. Predicted information is referred to herein as “deduced” information because it is deduced from declared and/or derived information based on statistical analysis. In this case the date is used to record a timestamp of when the calculation was performed.

FIG. 5 shows the predicted tables which include this so-called deduced information. Specifically, FIG. 5 shows that in this embodiment each of the relational tables 306, 308 and 310 comprise corresponding “predicted” tables 506, 508 and 510. In practice, the form of the predicted data structures, for example whether a separately recorded table or whether new entries within existing tables, is immaterial.

Broadly speaking, the difference is that tables 306, 308 and 310 relate to information that has either been declared by users or derived from usage patterns in practice, whereas the information in exemplary predicted tables 506, 508 and 510 has been predicted by the ASP. To achieve this the system uses a statistical engine 205, which performs a statistical analysis on the information to deduce “predicted” relationships. FIG. 2 shows the statistical engine 205 as being separate from the content engine 204, however it should be appreciated that in an alternative embodiment the functionality of the statistical engine could be integrated into the content engine. An exemplary type of statistical analysis is explained hereinafter with reference to FIGS. 5 to 13. The following prediction tables result:
A predicted profile table 510 comprising an indication of types of information each user is probably most likely to be interested in. For example an entry in a predicted profile might reflect “interest in horror movies” i.e. a type of film.
A predicted classification table 506 comprising an indication of the categories each piece of content should most probably be included in (i.e. auto generation of meta-data or similar for the content).
A predicted behaviour table 508 which predicts the pieces of content that each user is most likely to be interested in. For example, an entry in a predicted behaviour table might indicate an “interest in Scary Movie2 trailer” i.e. a specific item of content. Accordingly, we may expect predicted “types” of interest to be related to an interest in specific items of content—indeed it is this circular relationship which is exploited to derive and test predictions.

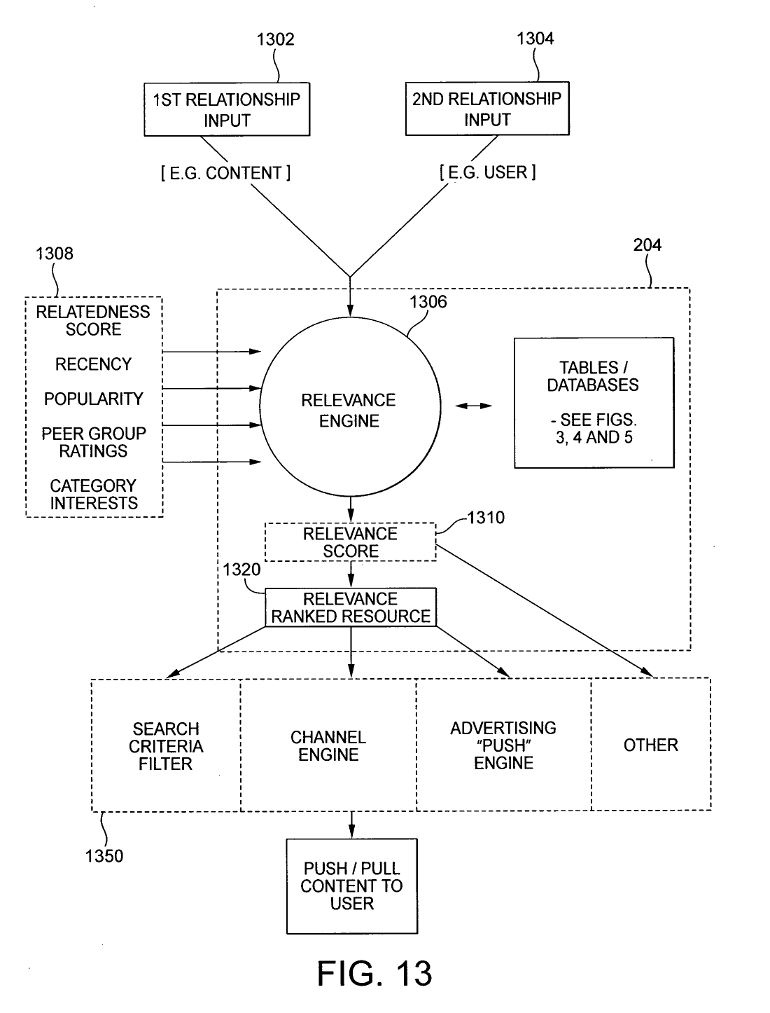

With reference to FIG. 13, relevance determinations within the system are driven by the summation of weighted scores. Exactly which items are taken into account and how these are weighted and summed is a configurable element of system. First and second inputs 1302, 1304 between which a relationship is to be determined are supplied to a scoring and relevance engine 1306 capable of performing the relevance determination described herein. One or more further relevant factors 1308 may also be taken into account in the determination of overall relevance. In the example illustrated below the relevance of content to a user is determined and the relevant factors taken into account may include “relatedness score” (user or predicted), “recency” (date stamp of the relationship), “popularity” (number of readers), “peer group ratings”, and “category interests”. A skilled person will appreciate that different factors should be taken into account for different types of relationship. The relevance engine outputs a relevance score 1310, which is the measure of extent of the relationship and which is also suitable for achieving a comprehensive relevance ranking of content. This provides a relevance resource 1320 ranking all content (or defined sub-sets of content) in ascending order of relevance to a particular user.

As will be apparent to a skilled person, the relevance resource can be coupled with suitable types of filters 1350 (or several filters) in order to facilitate provision of relevant content to users. For example one type of useful filter to couple with relevance resource is a search filter which applies search criteria from a user to filter the content of the relevance resource to provide particularly relevant search results to the user. Another type of suitable filter is for example a channel configuration filter or a channel content filter. These are basic types of filters which assist content providers (say operators of a website or a portal) in pushing the most relevant channel configurations and most relevant channel content, respectively, toward users. Another type of filter is an advertising content filter for supplying particularly relevant advertising content to users.

It should be appreciated that a filter is any mechanism for applying real time interests (or expected current interests) of users to the relevance resource and to assisting with either a “push” of relevant content to the user (e.g. advert) of “pull” of relevant content from the user (e.g. search results).

Consider the case of user to document predicted scores. For a given document there may be consideration of:

1) Any explicit existing relatedness score for the document by this user (declared or derived) weighted by date.

Effect: Documents explicitly flagged of interest have higher relevance. Newer documents have higher relevance.

Note: this element of the score is of limited use to the user as they have already rated the document. It is however important for the overall relevance determination and validation of the rankings.

2) Any matching categories for the user and document with their associated scores weighted by a factor based on the product of the two scores and date.

Effect: Documents which are of a type the user has declared an interest in are of higher relevance. Newer interests have higher relevance.

3) A factor to allow for the number of users who have expressed an interest in the document (declared or derived).

Effect: Popular content has higher relevance.

4) Any scores for this document from peer group or otherwise “related users” weighted by the relateness score to this user.

Effect: How other users have rated this document effects it's relevance with respect to a given user. The more similar the other user is to this user the more effect their rating will have.

Note: related users is itself a predicted relationship table with an associated score. This predicted table is calculated by the weighted summation of user to document relateness scores and user to category relateness scores.

Advertisers are typically interested in reaching users most likely respond to adverts or promotions. Hence advertising filters are a particularly useful type of filter 1312 for coupling to the relevance resource 1320. For example a ranking of advertising content taking to account user and category relationships yields strong results, allowing advertisers to reach more highly relevant target audiences among the general public.

Thus, in summary the website hosted by the server 106 is responsible for providing relevant content to a user depending on the personal interests and attributes of that user.

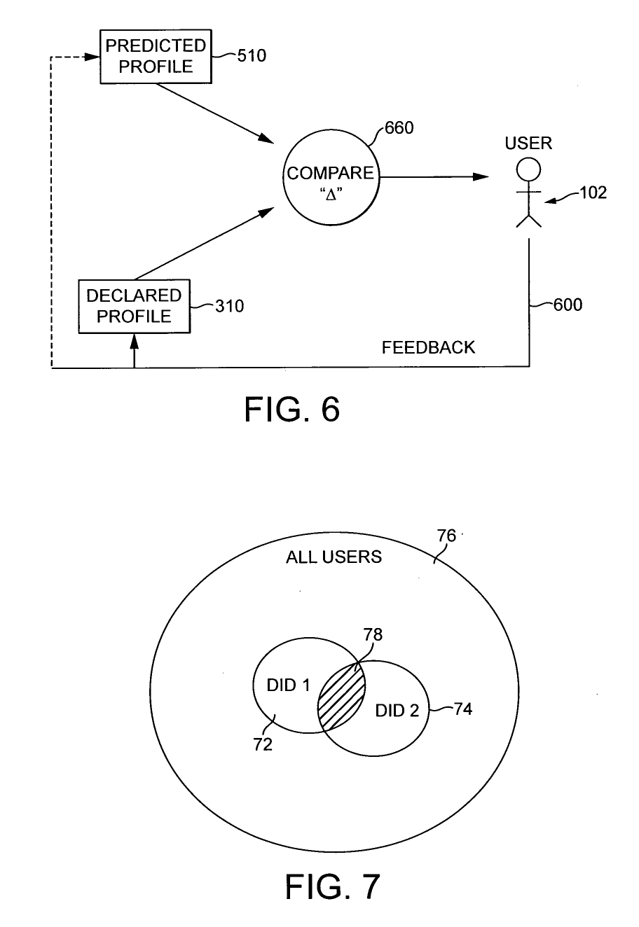

A particularly useful feature of the ‘predicted’ information is the ability for the content engine of the ASP to determine the difference between the predicted and actual relationships stored therein. FIG. 6 shows an example of a comparator 660 in the content engine 204 that is able to determine the difference “Δ” between the predicted and declared/derived information. Specifically FIG. 6 shows a predicated profile entry stored in table 510 being compared to a declared profile entry stored in table 310.

This result of the comparison, or difference “Δ”, can be used in a plurality of different ways:
i) to identify to users their interests, but which the users might not have been aware of or are outside the norm for their peer group (i.e. things which make them unique).
ii) to identify to users the interests of their peer group, but interests they do not appear to share (i.e. things they may be missing out on).
iii) the ability for the system to ‘self-tune’ based on statistical analysis to identify non-ideal predictions. That is, if the predicted information is very different from the declared/derived information, the content engine could be programmed to select one of the options as a default for retrieving the information requested. In an alternative embodiment, the content engine is able, through the interface 202, to request that the user provide information as to whether the declared or predicted information is more accurate.

At this point it is useful to discuss what is meant by a peer-group. Users often declare themselves members of peer groups, for example by joining online groups or forums. Alternatively, or in addition, users may be deemed to belong to a peer group based on user behaviour, for example the system can identify relatedness of users based on browsing behaviour. Alternatively, or in addition, the content engine 204 is able to deduce over time for individual users certain content that various users might be interested in and thereby draw predictions about relatedness of users. This is a type of deduced peer group. For example from the behaviour tables (of FIG. 3 and FIG. 5), a particular user, UID1 might be interested in a plurality of pieces of content DID2, DID3, DID7. The content engine is able to parse the information in this table and notice that another user UID2 is also interested in similar content and has accessed DID2 and DID7. If these shared pieces of content DID2 and DID7 are related to for example a particular category CID5 (or a new category can be generated for these peer group users), then a peer group can be formed consisting of the users UID1 and UID2. Thus, in addition to the information that UID1 might retrieve normally, the content engine 204 is further allowed to retrieve information that users in that user's peer group are interested in.

It is thus possible for a peer group relationship to be “deduced” as was the case for the other predicted relationships 506, 508 and 510 referred to in FIG. 5. Such peer groups would be deduced by performing a statistical analysis that aims to establish the degree of relatedness that might exist between particular users, or the content they access, in order to establish whether a user should be joined to a particular peer group.

According to a further embodiment, the content engine is able to deduce the predicted relatedness for entries in each of the primary tables 300, 302 and 304. While FIG. 4 showed an embodiment wherein the score that determined the relatedness was declared by a user for a relational table, each of the primary tables has a further column populated by predicted relatedness scores. That is, the content engine is able to score how related each of the primary items are to other items based on how they are used by various peer groups of users. These scores are referred to hereinbefore as “relatedness scores”.

For the content table 302, the extra scoring column (not shown) represented how each piece of content is related to each other piece of content based on usage (i.e. people who were interested in content A were also interested in content B). By grouping content in this manner it is also possible to generate categories of related content.

For the category table 304, the extra scoring column (not shown) represents how each category is related to other categories based on usage. For example, the socio-demographic category Y has a close affinity for ‘Horror’ movies.

For the users table 300, the extra scoring column (not shown) represents how each user is related to other users in terms of their interests, which allows the grouping of users into predicted peer groups of users having similar interests, i.e. deduced user peer groups.

A statistical engine 205 is provided with software able to generate the aforementioned deduced information (i.e. predicted tables). The functional aspects of exemplary software are described herein but it will be appreciated such software may take a number of different forms. However, the properties of an exemplary statistical engine 205 are most easily described with reference to the Venn diagram of FIG. 7. For each of the predicted tables, the statistical engine is required to determine the extent of the relationship between items in tables.

For example, to calculate the relatedness of two pieces of content (represented by DID1 and DID2), it is necessary to consider the intersection (or overlap 78 as shown in FIG. 7) between the set of users 72 interested in content DID1 and the set of users 74 interested in content DID2. Since we know the overall size of the users population 76 (for example those registered with the ASP), the statistical engine is able to use this as a reference to determine the statistical likelihood of the intersection (overlap 78) occurring by chance. The difference between the intersection in practice and the expected intersection based on overall the population of users indicates the extent which these pieces of content are linked by a theme of common interest (i.e. the extent of relationship between two pieces of content).

This type of statistical determination may be used to determine predicted contents of any of the predicted tables 506, 508, 510 and the like. According to another embodiment, it has been appreciated that the computing power needed to perform such statistical manipulations in working scenarios is prohibitive, or at least very inefficient.

A further advantageous embodiment is now described for performing this type of processing. In particular, according to a preferred embodiment the statistical processing is achieved by a combination of index and inverted-index processing techniques. In practice, inverted indexes are generated and stored locally each time a statistical analysis is performed. The content engine maintains these indexes and updates them each time a new analysis generates relevant entries for inclusion therein.

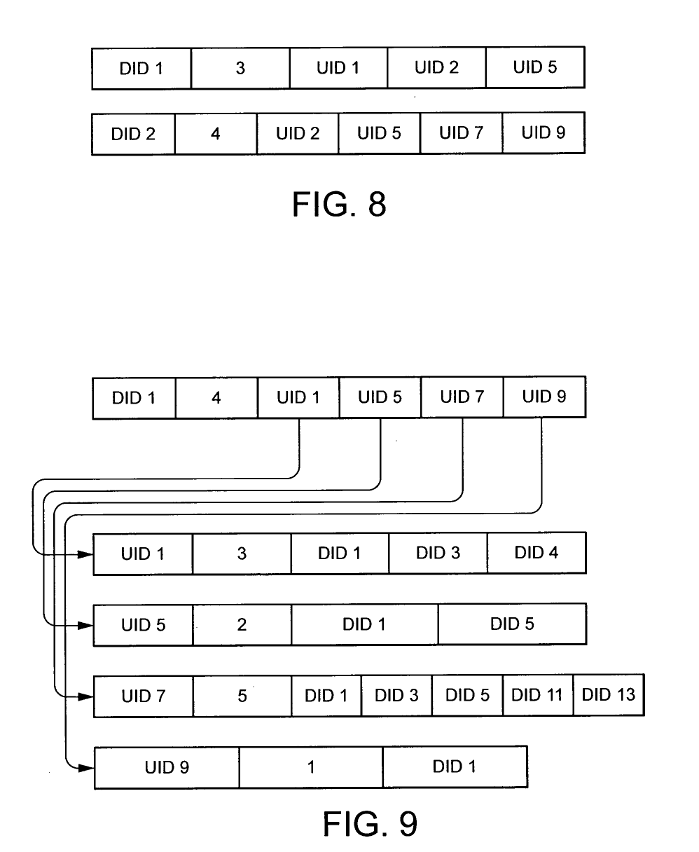

FIG. 8 shows a basic relational database “select statement” approach which could be used to calculate the intersection 78 between the two sets of users describe in FIG. 7. That is, the upper block of FIG. 8 represents the first set of users 72 that were interested in the first piece of content DID1. The relevant users are identified by their UIDs such that the users UID1, UID2 and UID5 are all interested in content DID1.

The lower block of FIG. 8 represents the second set of users 74 that were interested in the second piece of content DID2. The relevant users are identified by the UIDs such that the users UID2, UID5, UID7 and UID9 were all interested in content DID2.

Thus, using an inverted (de-normalised) index for the same relationship, this assumes content DID1 is of interest to users UID1,UID2, UID5 and that content DID2 is of interest to users UID2, UID5, UID7, UID9. Using this inverted index, the statistical engine is able to rapidly parse each set of inverted indices to establish that the intersection between these two sets is UID2 and UID5. That is, the users UID2 and UID5 access both DID1 and DID2.

It is possible to process such inverted index lists in parallel using for example an optimised merge-sort algorithm. Thus, the inverted index (i.e. UID) lists offer advantages in their own right in terms of reduced processing time, and this is potentially even further enhanced by being able to parse such lists in parallel (i.e. simultaneously).

FIG. 9 shows an example of the application of the inverted index technique described in FIG. 8 for determining the relatedness of all content to a given piece of content i.e. the relatedness of the entry of content DID1 to all other entries in the content table 302.

In order to perform this determination, the statistical engine 205 extracts all the inverted indexes (UIDs) for all the users that have shown an interest in content DID1. Thus, the inverted content index list 900 comprising UID1, UID5, UID7, UID9 is generated. Then, each of the UID indexes can be processed in parallel to rapidly calculate the intersection (overlap) between all of these sets.

Additionally this approach is highly efficient since the compact nature of (inverted) index lists means all data required for relatedness determinations may be loaded and held in a local memory of the statistical engine to be processed simultaneously. When indexing the entire database, or a large part of it, the control process can be configured to work on items already in local memory first, minimising delays due to slower memory access-based operations.

The statistical engine used to calculate relatedness operates, as already mentioned, based on statistical techniques that take into consideration the size of overlapping sets. Considering the example shown in FIG. 9, it can be seen for example that for DID5, the relatedness is based on the intersection of the two overlapping user index lists UID5 and UID7. Moreover, the affect of each of these index lists should be inversely proportional to the size of each of these index lists. UID5 is a list comprising 2 entries, whereas UID7 is a list comprising 5 entries and therefore the former has an affect of ½, whereas the latter only has an affect of ⅕. This must then also be adjusted to take account of the maximum value possible for this document, which is naturally the same as the relatedness value for a document with itself—DID1 in this case.

In a further embodiment, an optional factor may be added regarding the ‘popularity’ of the item delta 2 in the example to help ensure popular content precedes less popular content.

Where scoring is available for the relationship tables this is additionally used to refine the output from the relatedness algorithm. In this case each user score is weighted by a factor of 1(UID1−>DID1)*(1−modulus(I(UID5−>DID1)−I(UID1−>DID1)/max I).

Numeric Explanation:

I(UID1−>DID1)=Score for User

(1−modulus(I(UID5−>DID1)−I(UID1−>DID1)/max 1)=difference between user 1 and user 5 scores on a scale of 0 to 1; where 1=very similar and 0=not very similar

### EXAMPLE

Suppose UID1 Scores DID1 at 9 (on scale of 0-10) and UID5 scores DID1 at 8

Our subsequent relationship score would be: 9*(1−mod(8-9)/10) =9*(1− 1/10)=9* 9/10=8.1

Where I(user−>doc) is the score of the given document with respect to a given user.

It should be appreciated that the primary tables can be built up with declared information. For example, a profile table 310 can be built up by the ASP 106, for example in response to the user answering a series of questions posed by the ASP. According to an embodiment the questions are grouped into batches of questions by the ASP 106 wherein the answers supplied by the user to a previous batch of questions are processed by a content engine 204, and based on the answers, the subsequent batch of questions prepared by the content engine are able to take into account the answers supplied to the previous batch of questions. In this way, the content engine 204 of the ASP 106 is able to ask progressively more relevant questions to the user and hence has the advantage of increasing the accuracy of the declared profile 310 of a user.

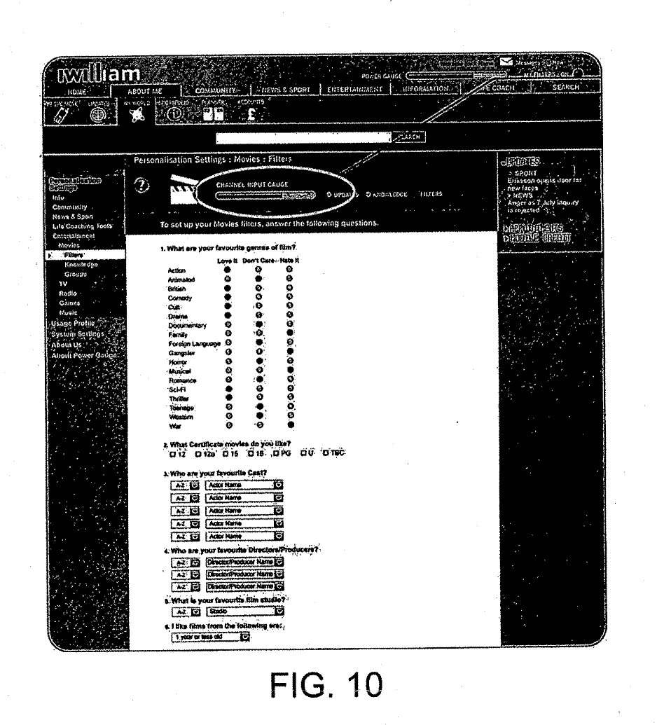

FIG. 10 shows an example of a screen of the interface 202 provided by the ASP 106 to the user, wherein the user is asked to complete a plurality of questions 1 to 4. An embodiment according to the invention is a web portal enabling students to receive the most relevant information at the relevant stage in their life experience. For example, students that go on to University are potentially faced with a huge diversity with regards to the standard of guidance received from their guardians (for example, such guardians can take on a plurality of different forms such as teachers, parents, friends, siblings, publications, TV etc.). Moreover, each student will also have their own priorities and interests, and at various stages in their development will face complications that are unique to them. An advantage of the web portal application of the present invention is that relevant information can be given to a student, which is tailored to take into account a student's age, interests and circumstances. This is useful in enabling the student to make the correct decision with regards to their life goals and the means for achieving them.

The web portal application of the present invention uses web-based technology in order to implement this resource tool for students. It can act as a reference tool for them throughout their University life and also afterwards, for example when searching for employment. It is based on the analogy of a best friend who is cleverer than the user, but has all the contacts and advice that a user can make use of without feeling bad.

An example of such a web portal application could be in the form of a online search engine which is able to account for the following aspects:
choosing the right career for the user while still having flexibility if the user's aspirations change over time.
at each stage of the user's development outlining the potential choices open to the user, for example from GCSE all the way through to recruitment and employment.
an online holding form to constantly monitor the career path or University progression of a user as their grades and social requirements alter, thereby enabling the profile of the user to change as the user develops and with their changing aspirations.
to deliver content which is up to date by offering current courses at University or job availability in the market sector, and use the navigable system for interfacing with the current UCAS system of University application.
a registration process to enable a user to be notified of any changes or information with regards to a predicted career path. The registration process also enables a user to interact with other students that have similar aspirations thereby increasing the user's knowledge base and his social skills. Specifically, this can be achieved by using the afore-described peer group concept, for example by deriving which of the other users most closely match the aspirations of the user in question. This peer group concept can also be extended so as to receive editorial information about the University course or career path taken by a user from people having knowledge in these areas, for example current students, previous students, employers etc.
a complete registration and booking system for numerous aspects including:
   accommodation, availability and cost;
   University life specific to the choices of the user;
   University campus/local town facilities and information;
   offering advice on financial commitments of a user and tools for achieving maximum financial security;
   tips for leaving home for the first time;
   full personal safety report advising a user on how to behave during their stay at University.

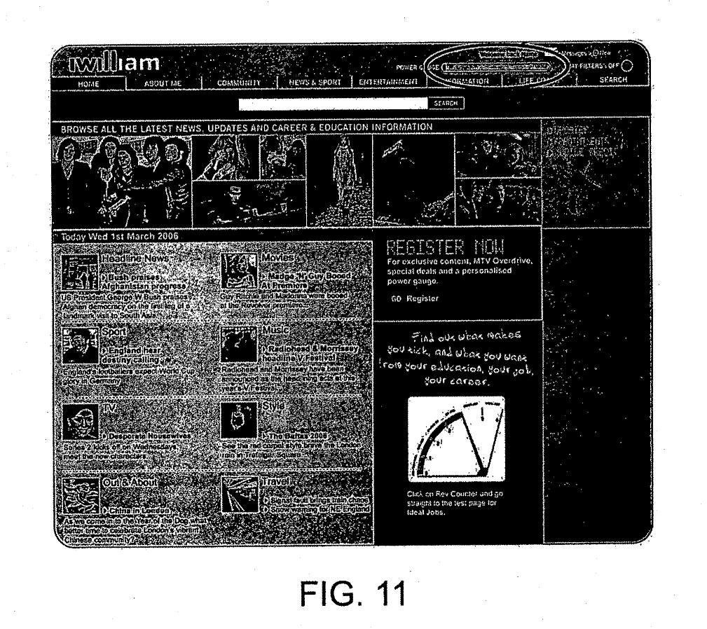

Thus, in order to make user of the web portal application of the present invention, a user would need to register with the ASP 106 and provide a valid email address to be used as the user name and choose a password to allow access to the web portal. According to one embodiment, during the registration phase, the web portal is configured to-pose a series of basic questions to the user in-order-to build up a basic declared information profile for the user. As the user makes use of the web portal over time, the declared profile will increase, for example by answering further and progressively more pertinent questions or increase the derived information profile through the web usage and/or channels accessed by the web user. That is, FIG. 11 shows a screen shot wherein the user can select from a plurality of channels including “headline news”, “sport”, “TV”, “out and about”, “movies”, “music”, “style”, “travel” etc.

Thus, the web portal application is able to use the content engine 204 of the ASP 106 and the interactive input from the user to tailor more precisely the information to be presented to the user for enabling more relevant advice to the user and which is able to take into account changing aspirations of the user over time. The content engine 204 is for example able to interrogate the declared profile and predicted profile to arrive at a more accurate model for providing the most relevant content and information to the user.

The user interface 102 of the web portal application provided by the ASP 106 has a plurality of different options allowing the user to stylise the interface as desired. For example, the user interface having a variety of completely different “skins” that provide a different look and feel depending on the age of the user and their progress throughout the education system. This can be set so that as the user progresses through various age groups the skins are updated automatically.

Also, the content of the home page, for example the channels that are listed and the specific areas of functionality that can be accessed also depend on the user's age according to one embodiment. For example, at 14 years old the user might be provided with very general careers advice, whereas at 16 they might be encouraged to start thinking about subjects to study at University, and at 18 they might be offered the opportunity to sign up for a credit card, etc.

Thus, in general the content of the portal will evolve and grow with the user as their interests change over time, and where newly accessible features are highlighted as they become available.

An advantage of the web portal application is that it is dynamic and personalised so as to make the tool as relevant as possible to each individual user. The system is also intelligent enough to handle users who do not fit the typical profile. For example, the content displayed to a particular user is not typically based on age and can take into account situations where for example, some users have taken a gap year.

A further advantage of the web portal application is that the questions asked during the registration process have the following characteristics:
asking questions one or two at a time and not in the form of a single long list. The number of questions is carefully selected to be as short as possible, but wherein it is still possible to obtain the minimum information necessary for the portal content to be personalised sufficiently for first use.
the content engine being interactive to emphasise the dynamic nature of the web portal for example by changing the colour of the screen background when a user is asked to type in their favourite colour.

An example of some of the basic questions that will be required during registration are:
first name and last name;
nickname;
gender;
date of birth;
regional domicile;
email address;
current school/University

The web portal is also flexible in allowing each user to change their password as desired.

The declared profile is an important source of knowledge for determining the interests, aspirations and attributes of each user. In order to develop the declared. profile, the user is exposed to a series of tests. The more of these tests that the user completes, the more accurate the declared profile of the user is likely to be. The set of supported tests is not exhaustive, for example it includes the following:
career preference test
likes and dislikes
proactive factors (i.e. specific career decisions that the user has already made)
financial
psycho-dynamic
aspiration
career choice
location of learning
subject likes and dislikes
learning aptitude
job fit
ideal job

All of the test results for the user are stored in the declared profile and will effect the subsequent personalisation of the web portal application for that user. For example to determine what career suggestions are made, which product reviews the user is prompted to read, etc. Hence the user will be using the web-based portal over an extended time period, the user will also be able to go back and retake certain tests at a later date, and in any event this may be mandatory in some cases where the test results have a limited useful life.

It is also significant that all declared profile-based search results are stable. For example, if a user retakes a test and gives different (but overall similar) answers, this should not have material consequences in terms of the personalisation of results displayed, since otherwise the portal may appear to exhibit somewhat random behaviour and user confidence would be reduced. This stabilisation effect is largely achieved by way of the predicted profile 158 and the comparison circuitry 660 which is able to negate any spurious data. Indeed, any changes A detected by the comparison circuitry can for example be reported to the user 102 for further clarification or may be asked in a successive series of tests posed to the user for resolving this difference.

In further embodiments of the web portal application, the web portal provides an interface for allowing chat rooms or message boards to allow students to communicate with other users/students that have similar interests and therefore fall within the peer group of the user in question.

A further advantage of the web portal is to automatically provide relevant job searches that match the users declared profile. It is useful in that the user can be presented with the job opportunities that are most likely to be of interest as the student progresses, or alternatively once he has completed his course and looking for full time employment. Furthermore, the user can choose to perform a non-profiled search by deselecting the “Profile ON” button in order to provide a greater range of available jobs. Moreover, it should be appreciated that variations between these extremes are also possible, wherein the user is able to update the declared profile specifically for job searching by deselecting elements of the declared profile which might narrow a search unnecessarily. Also, the user is able to select between applying the declared profile, the predicted profile, or combinations of profiles as described hereinbefore, to see a different and perhaps more relevant set of result appears.

Thus, the web portal application advantageously allows automatic cross references of the job prerequisites against the user's declared profile and indicates whether the user has all of the relevant qualifications and experience to meet the job requirements.

Moreover, because of the web-based nature of the portal, the user is able to apply for the job online by completing an application which for example is emailed to the employer. The email may contain the user's standard CV and covering letter or may include information specifically requested by the employer and supplied by the user, depending upon the job requirements. The web portal application provides the ability of tracking the application at all stages, and providing the user with email notification of any updates on the progress of the application.

It should be appreciated that channels in the web portal application can be tailored in line with the interests of the user based on the content engine 204. For example for the “News” channel, the web portal provides an online news service. Thus, users can either specifically input which new topics they are interested in or alternative each user can opt to receive news items that match the interests in their profile. Also users can request to receive news update bulletins by email and again these bulletins will link back to the web portal interface so as to encourage return visits to the site.

The web portal application also has important ramifications in respect of advertising and making use of products and services from third party partners. For example, having established trade rights, the user is able to deal/contract directly with the relevant third parties through the web portal of the present application.

Some of these services and products could for example include:
a bank account, for example an online bank account provided by a major UK retail bank;
insurance, for example travel, home contents and car insurance schemes;
phone services, for example discounted talk plans from major phone networks;
broadband services;
web search, powered by a major search engine potentially with customised results, for example by applying filtering based on either the declared profile or the predicted profile.
books, for example both general books of interest and specialised text books relevant to a University course.
computer hardware and software;
music and videos, for example CDs, DVDs etc.
retail high street brands, for example by providing links through to online shops.

Furthermore, the web portal application is advantageous in allowing direct marketing against a target subset of the users of the ASP 106. This is a potentially and particularly powerful advertising tool which should attract a premium from potential advertisers, since the users in the database have potentially already been sorted by their declared profiles and web usage, which would allow the advertisers to target users by matching the interests of the relevant users with the third party requirements.

According to an alternative embodiment, the web portal application is also accessible through other technologies, i.e. apart from the standard web browser internet connection. For example, the web portal application is accessible through WAP-enabled mobile phones, Third Generation (G3) mobile phones, WEBTV™ applications, etc. It should also be appreciated that although the term mobile phone is used, any mobile terminal equipped with such technology, for example a PDA (Personal Digital Assistant), laptop or other relevant handheld device equipped with such technologies are equally applicable.

A further advantage of the web portal application is that an extensive profile can be built up on the habits and behaviour of individual users. This extends not only to the profile information collected from the questions, but also to areas such as which features of the site they use most frequently, and which third party products and/or services the users make use of most frequently.

Indeed, an I-Portfolio 707 can be built up user profiles comprising the declared, derived and deduced knowledge in relation to each user. The I-Portfolio is an evolved electronic portfolio which is user centric and user controlled. It should be appreciated that while the I-Portfolio is shown as a discrete component in the ASP it can be integrated into the content engine 204.

As will now be understood, the declared profile of each user is voluntarily imparted personal information relating to the user, which for example could include the following:
age and gender;
demographic and psychographic details;
learning patterns;
type of personality, i.e. extraverted, introverted, etc;
individual personality preferences;
learning preferences;
type of intelligence;
skills, interests and preferences;
environmental preference for learning;
entertainment preferences.

There are a plurality of different mechanisms for obtaining the declared knowledge from the user, which include:
personal testing;
filtration;
pre-search;
knowledge;
group;
community.

Each of these mechanisms for collecting declared knowledge will be briefly discussed now.

This Personal Testing method of obtaining declared knowledge comprises the use of taking a selection of psychometric-based tests. The tests are set up to perform two main functions which are the categorisation of the user and the weighting of the user's personal attributes. The results of the user tests will determine into which of the types the user is categorised into. Further results from the testing are then quantified into a set of numeric values that are stored within the I-Portfolio and correspond to the user's unique identity. That is, each user having a unique ID for identifying that user.

According to a further embodiment, the user is able to turn off the personalisation testing by selecting a “profile OFF” button located on the navigation bar of the web portal interface. That is, when the profile button is off “i.e. deselected” then the content which is retrieved from a database is not sorted by the content engine and instead defaults to the preference settings relevant to the particular interface that the user is viewing the content with. However, when the profile is on “i.e. selected”, the content engine 204 applies the knowledge learned about the user to the content that the user is passively viewing or proactively browsing.

The advantage of this is that the user is able to subconsciously maintain the accuracy of their declared profile, by allowing the content engine to autonomously perform a matching of the user's web usage as compared to the user's actual declared profile. Any web transactions that are conducted with the filters off are not stored in the declared profile but are generically against users of this type (i.e. a peer group or content with a similar categorisation).

According to a different embodiment an intelligent search facility is provided which enables the user to perform a text search for content stored either within the ASP database or remote databases over the web. In order to engage this facility, the “profile ON/OFF” button is turned on such that the user's I-Portfolio is applied to the contents in the databases such that the returned search results are more relevant to the user's interests and attributes as represented in the I-Portfolio.

The second form of declared knowledge is filtration whereby the users are encouraged to input data in order to create filters depending on the user's requirements. The filters can relate to all elements of life choices and provide filtered information back to the user. That is, the content engine of the web portal application sorts the type of filtered information such that it is relevant to the user's personal attributes as well as to the user's interests. For example, the user with an extraverted personality would receive information in a more ostentatious form, for example a 30 second video clip, whereas an introverted user that requests the same information will be presented this information in a more learned format for example a 300 word article. In order to emphasise the concept of user centricity of the I-Portfolio, all users are able to select content to be provided unfiltered.

According to another embodiment of the present invention there is provided pre-search functionality in the content engine 204 of the ASP 106. This is an enhancement of filtration in that the pre-search allows a user to set parameters for a particular piece of information that they would like to be made aware of at some point in the future when and if the information becomes available. For example, the user can set a pre-search stating that they wish to see the pop group U2 any time in the next two years within ten miles of London. Every time the user logs into the web portal application, the content engine will carry out a search of the latest relevant content available to it.

A further form of declared knowledge is to test a user for levels of detail which cover the user's:
behavioural patterns;
purchasing patterns;
sociological patterns;
sociological attributes;
entertainment preferences across all levels of content.

In this embodiment, the questions are put to the user in four progressive levels which determine the structure of the following level and this process creates a progressive focus of information relevance. That is, the declared knowledge of the user can be made more and more accurate over time by progressive testing which takes the results of previous questions and applies them in formulating more relevant questions at the next level of questions posed to the user.

In one regard, derived profile information may be regarded as a specific case of declared data; in that it is really user driven information which is collected automatically based on usage rather than from explicit declarations from the user. Preferred embodiments deal with this internally via weighing mechanisms which reflect a confidence level concerning the usage based data. For example browsing to some free content will record the interest in the appropriate relationship table with a certain weight, but buying content would give a more significant weight.

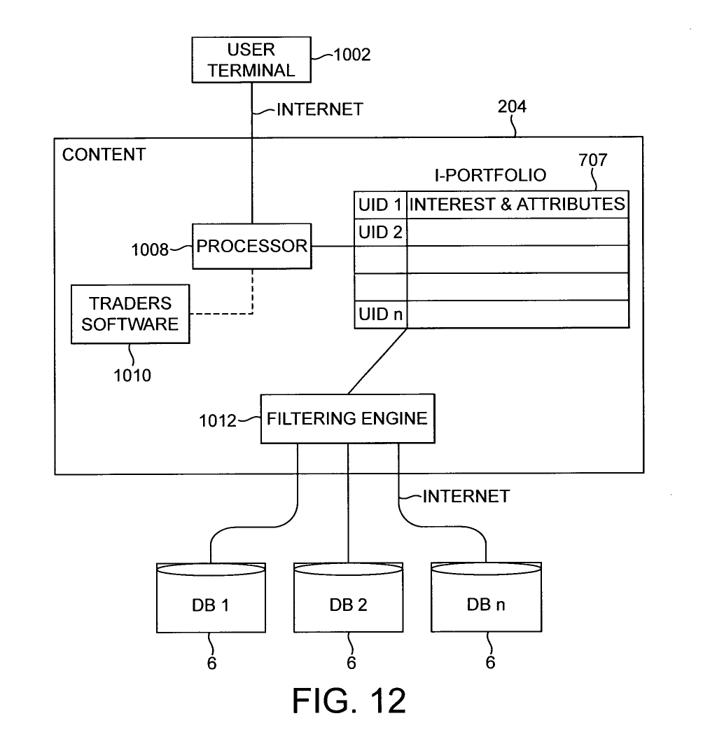

FIG. 12 shows an example of a web content engine 204. The web content engine is shown as having a plurality of different components including the processor 1008, an I-Portfolio, containing among other information, user profile information in the various forms described hereinbefore, tracking software 1010 and a filtering engine 1012. It should also be appreciated that the processor is able to execute computer programs for carrying out all of the various functions of the content engine already described herein. The I-Portfolio thus comprises profile information on the plurality of users that have registered with the web portal application and maintains their interests and attributes as obtained from the 3D knowledge engine. The tracking software 1010 is used to monitor the web usage of each user terminal and to compare said web usage with the interests and attributes stored in the I-Portfolio, and to cause updating of relevant table entries as appropriate. Moreover, a filtering engine 1012 is shown which is able to sort through content from remote databases (accessed over the internet) or a local database (not shown) by comparing the content against the interests and attributes of each user so as to provide the user with more relevant content, content in more appropriate formats, and/or more appropriately prioritised content.

Those skilled in the art will appreciate that while the foregoing has described what is considered to be the best mode and, where appropriate, other modes of performing the invention or inventions described herein, the inventions should not be limited to the specific apparatus configurations and methods disclosed in this description. Embodiments within the scope of the novel and inventive concept can be implemented in any available way. Embodiments may comprise individually advantageous features and/or any combinations of the plurality of advantageous features described. Those skilled in the art will recognise that such inventions have a broad range of applications in many different types of computing and relevance determination applications.

1. A computer system for determining the relevance of stored content to particular users and for facilitating the provision of relevant content to individual users, the computer system comprising:
a content engine comprising user profile information representative of interests and/or attributes of individual users; and
a processor for determining relevance of content to a particular user based on said user profile information.

2. A computer system as in claim 1, wherein the user profile information comprises information about the user which is declared by the user.

3. A computer system as in claim 2, comprising means for generating prompts for capturing declared information from the user, wherein said prompts comprise one or more of a form and a series of questions to the user.

4. A computer system as in claim 3, wherein said means for generating prompts generates a series of questions, such that one or more of the questions in the series is generated dependent on an answer to a previous question in the series.

5. A computer system as in claim 3, wherein said means for generating prompts generates a plurality of series of questions, such that one or more series of questions is generated responsive to at least one answer in a previous series of questions.

6. A computer system as in claim 1, comprising a module for receiving usage information and wherein the user profile information comprises information about a user which is derived from observations of the user's usage behaviour.

7. A computer system as in claim 1, comprising a statistical engine and wherein the user profile information comprises predicted information which is deduced based on statistical processing of information declared by users.

8. A computer system as in claim 1, comprising a statistical engine and wherein the user profile information comprises predicted information which is deduced based on statistical processing of information derived based on the usage behaviour of users.

9. A computer system as in claim 1, comprising a statistical engine and wherein the user profile information comprises predicted information which is deduced based on statistical processing of (i) information declared by users and (ii) information derived based on the usage behaviour of users.

10. A computer system as in claim 1, wherein the user profile information comprises records of relationships between one or more of (i) users, (ii) content and (iii) categories, and wherein the content engine records score information indicating the significance of relationships recorded in the user profile information.

11. A computer system as in claim 10, comprising means for generating a prompt inviting a user to input score information indicating the relevance of content presented to the user by the content engine, wherein the score information comprises score information provided by users responsive to said prompts.

12. A computer system as in claim 10, comprising a module for receiving usage information and wherein said content engine records score information indicating the significance of relationships recorded in the user profile information, wherein the score information comprises score information derived by monitoring usage behaviour.

13. A computer system as in claim 10, comprising a statistical engine, wherein said content engine records score information indicating the significance of relationships recorded in the user profile information, and wherein the score information comprises score information deduced from statistical determinations.

14. A computer system as in claim 10, wherein the score information takes into account the relative age user profile information.

15. A computer system as in claim 14, wherein the score information takes into account time elapsed since user profile information was declared by a user.

16. A computer system as in claim 14, wherein the score information takes into account time elapsed since events providing usage-based user profile information occurred.

17. A computer system as in claim 10, wherein the score information takes into account the current popularity of a particular content or category.

18. A computer system as in claim 10, wherein the score information takes into account a measure of the user's interest in a particular content or category, which measure is derived from usage observations.

19. A computer system as in claim 10, wherein the content engine is provided with means for generation a nominal score which is or replaced by one or more of score information based on user declarations or score information based on usage observations.

20. A computer system as in claim 1, wherein the content engine comprises a category table comprising a list of categories each having a unique category ID.

21. A computer system as in claim 1, wherein the content engine comprises a content table comprising a list of content items each having a unique content ID.

22. A computer system as in claim 21, wherein the content table comprises content items.

23. A computer system as in claim 20, wherein the content table comprises pointers to items of content.

24. A computer system as in claim 23, wherein said pointers to items of content comprise links to items of content accessible via the Internet.

25. A computer system as in claim 1, wherein the content engine comprises a user table comprising a plurality of users each having a unique user ID.

26. A computer system as in claim 1, wherein the content engine comprises at least one relational table.

27. A computer system as in claim 26, wherein said relational table comprises score information indicating the significance of relationships recorded therein.

28. A computer system as in claim 1, wherein the content engine comprises a behaviour table recording relationships between individual users and individual items of content.

29. A computer system as in claim 1, wherein the content engine comprises a classification table recording relationships between individual items of content and individual categories.

30. A computer system as in claim 1, wherein the content engine comprises a profile table recording relationships between individual users and individual categories.

31. A computer system as in claim 28, wherein at least one table recording relationships comprises predicted relationships based on statistical analysis.

32. A computer system as in claim 31, wherein a plurality of tables recording relationships comprise predicted relationships based on statistical analysis.

33. A computer system as in claim 6, wherein said content engine comprises means for comparing declared information of the user's profile with information derived from the users based on usage.

34. A computer system as in claim 7, wherein said content engine comprises means for comparing predicted information of the user's profile with one or more of information declared by the user or derived from the user's usage.

35. A computer system as in claim 1, wherein said content engine comprises a table recording peer groups of users based on one or more of: registration of a user with a particular group; usage behaviour of a user; and prediction based on statistical analysis.

36. A computer system as in claim 1, wherein a table records a peer group based on common content interests.

37. A computer system as in claim 1, wherein a table records content accessed by similar users as likely to be linked by a common theme.

38. A computer system as in claim 1, comprising a statistical engine arranged to determine the extent of relationship between first and second table populations having regard to a reference population.

39. A computer system as in claim 38, wherein said statistical engine is coupled to receive populations and determine the extent of relationships between one or more of: first and second content populations; a first category population and a second category population; a first user population and a second user population; a first content population and a category population; a first category population and a user population; and a first user population and a content population.

40. A computer system as in claim 39, wherein said statistical engine is capable of determining the extent of relationships between more than two populations.

41. A computer system as in claim 1, wherein the content engine comprises one or more relationship tables, and wherein the content engine comprises index representations of information in at least one relationship table.

42. A computer system as in claim 1, wherein said user profile information comprises all information about the user required to make the relevance determination.

43. A computer system as in claim 2, wherein information declared by the user falls into one or more of the following categories: age; gender; demographic information; psychographic information; learning patterns; personality type; individual personality preferences; learning preferences; intelligence type; skills; interests; region of domicile; environment preferences; entertainment preferences; and general preferences.

44. A computer system as in claim 2, comprising software to support one or more of the following types of declared information gathering: user testing; filtering based on a user input; a pre-search; usage patterns; purchasing patterns; sociological patterns; sociological attributes; entertainment preferences; and indications of groups and/or communities relevant to the user.

45. A computer system as in claim 1, wherein an interface presented to the user provides a means for the user to switch off relevance determination based on the user profile.

46. A computer system as in claim 1, wherein an interface presented to the user provides a means for the user to select from among user profile criteria applied in relevance determination.

47. A computer system as in claim 1, comprising software supporting notification of developments to user e-mail accounts.

48. A computer system as in claim 1, comprising communications interfaces facilitating communication between users.

49. A computer system as in claim 1, comprising means for presenting a plurality of channels of content to a user, wherein aspects of the selection and/or configuration of said channels are selectable by the content engine based on a relevance determination.

50. A computer system as in claim 1, wherein the content engine is arranged to select content within a channel presented to a user based on a relevance determination.

51. A computer system as in claim 1, comprising third-party content relating to products or services offered to users.

52. A computer system as in claim 51 , comprising an interface through which users can tailor aspects of the system as viewed by them.

53. A web portal supporting development of individual users over time, the web portal comprising:
a content engine for determining the relevance of content, said content engine comprising user profile information representative of individual interests and/or attributes, wherein said user profile information comprises one or more of:
(a) information declared by users about themselves;
(b) information about users derived from observations of their usage behaviour; (c) information about users determined based on statistical analyses of (a) or (b) or both (a) and (b); and
means for comparing said user profile information with the content to determine relevance of a particular piece of content to a particular user.

54. A web portal as in claim 53, comprising data selected from or more of the following categories: academic courses; career guidance; job opportunities; and location based amenities.

55. A web portal as in claim 54, comprising information on job opportunities, and further providing an interface for one or more of: job searching; online job applications; and tracking job applications.

56. A method of operating a computer system to determine relevance of content, the method comprising:
accessing recorded information about one or more of: users; categories; and content, which information is declared by users and/or derived from observations of user's behaviour, wherein said information comprises a plurality of populations;
establishing an intersection between selected ones of said plurality of populations; comparing said intersection with a reference population to determine an extent of relationship between said selected pluralities of populations; and
using said extent of relationship to determine a predicted relationship.

57. A method as in claim 56, wherein said recorded information comprises index lists and said the step of establishing an intersection is achieved by scanning a plurality of such index lists.

58. A method as in claim 57, wherein said index lists comprise at least one inverted index list.

59. A method as in claim 57, wherein said scanning of a plurality of index lists occurs substantially contemporaneously.

60. A method as in claim 57, wherein the influence of an index list on the determination is dependent on the length of the list.

61. A method as in claim 57, wherein scanning of a index list is performed by means of an optimised merge-sort algorithm.

62. A method as in claim 56, wherein said predicted relationship comprises a relationship between one or more of: a user and a category; a user and an item of content; an item of content and a category; first and second items of content; first and second users; and first and second categories.

63. A method as in claim 57, wherein a plurality of index lists to be scanned are loaded into a memory to facilitate the step of establishing said intersection.

64. A method as in claim 57, wherein said index lists are extracted from information including information held relational tables of a content engine.

65. A method as in any of claim 64, further taking into account scores indicated in relational tables of a content engine.

66. A method as in claim 65, wherein scoring takes into account the age of information declared from the user and/or the age of information derived from the usage, such that more recent information is afforded a score giving it more significance.

67. A method as in claim 65, taking into account timing of declared and or derived information such that more pertinent information carries more significance.

68. A server application comprising a content table comprising a list of content items each having a unique content ID, wherein the list of content items comprises content items sourced from within a network administered by the operator of the server application as well as content items sourced from the Internet.

69. A server application as in claim 68, wherein said content table comprises links to content sourced from the Internet.

70. A method of building a content table in a server, the content table comprising content items sourced from within an environment administered by the operator of the server as well as content items sourced from the Internet; the method comprising providing the server with software causing an entry to be made in said content table responsive to users registered with said server accessing items of content, irrespective of whether the item of content accessed is from within the environment administered by the operator of the server or from Internet.

71. A content engine for determining the relevance of stored content to particular users and for facilitating the provision of relevant content to individual users, comprising user profile information comprising information based on information about users declared by the relevant users and information about users derived from observations of usage behaviour.

72. A content engine for determining the relevance of stored content to particular users and for facilitating the provision of relevant content to individual users, comprising user profile information based on one or more of information about a users declared by the relevant users and information about users derived from observations of usage behaviour, wherein said user profile information further comprises information predicted about users based on statistical analysis of said declared and/or said derived information.

73. A content engine for determining the relevance of stored content to particular users and for facilitating the provision of relevant content to individual users, comprising user profile information representative of interests and/or attributes of individual users, wherein said user profile information comprises information predicted by said content engine, and said content engine further comprises means for receiving from the user an indication of accuracy of said predicted information.

74. A content engine for determining the relevance of stored content to particular users and for facilitating the provision of relevant content to individual users, comprising a table recording relationships between individual users and individual items of content.

75. A content engine for determining the relevance of stored content to particular users and for facilitating the provision of relevant content to individual users, comprising a table recording relationships between individual users and individual categories.

76. A content engine for determining the relevance of stored content to particular users and for facilitating the provision of relevant content to individual users, comprising a table recording relationships between individual items of content and individual categories.

77. A content engine for determining the relevance of stored content to particular users and for facilitating the provision of relevant content to individual users, comprising a first table recording relationships between individual items of content and individual categories and a second table recording relationships between individual users and individual categories.

78. A content engine for determining the relevance of stored content to particular users and for facilitating the provision of relevant content to individual users, comprising a first table recording relationships between individual items of content and individual users and a second table recording relationships between individual users and individual categories.

79. A content engine for determining the relevance of stored content to particular users and for facilitating the provision of relevant content to individual users, comprising a first table recording relationships between individual items of content and individual users and a second table recording relationships between individual items of content and individual categories.

80. A content engine comprising means for predicting aspects of relationships between one or more of users, content and categories, and further comprising means for determining a difference between predicted relationship information and corresponding information declared from the user or derived based on usage behaviour.

81. A content engine comprising relationship tables recording relationship information concerning two or more of users, content and categories, and further comprising index representations of at least some of said relationship information, wherein said index representations are accessible to a statistical engine for determining the extent of relationships for use in determinations of relevance.
